(19) United States
(12) Patent Application Publication
(10) Pub. No.: US 2024/0050963 A1
(43) Pub. Date: Feb. 15, 2024

(54) MODULAR SHOWER HEAD ASSEMBLY

(71) Applicant: Marco Antonio GARCÍA VILLAREAL, Monterrey, Nuevo Leon (MX)

(72) Inventor: Marco Antonio GARCÍA VILLAREAL, Monterrey, Nuevo Leon (MX)

(21) Appl. No.: 18/268,230

(22) PCT Filed: Dec. 18, 2020
(86) PCT No.: PCT/MX2020/000061

§ 371 Date: Jun. 18, 2023

(51) Int. Cl. B05B 1/18; B05B 1/30

(52) U.S. Cl. CPC B05B 1/18; B05B 1/30

(57) ABSTRACT

The present invention relates to a modular shower head assembly, the assembly comprises a water flow regulator module, a swivel adapter and a shower head, a restrictor diffuser has been incorporated into both the water flow regulator module and the swivel adapter module to homogenise the turbulence and deliver a smooth flow, so as to obtain a soft, uniform curtain of rain, in addition, each module is interchangeable in such a way that it can be used according to the user's needs, the assembly is scalable, as the user can purchase each piece separately and couple them together until having a modular shower head assembly, it should be noted that said modules can be used with other shower heads.

### FIELD OF INVENTION

This invention refers to a modular assembly for a shower head, which integrates a water flow regulator module, a swivel ball adapter and a shower head object of application PCT/MX2018/000107. More particularly, this invention refers to a modular assembly for a shower head, which is made up of interchangeable modules, and can even be used with any shower head since its coupling form is universal.

### BACKGROUND OF THE INVENTION

Currently there are many variants of shower heads, there are shower heads that are offered on the market as single pieces, that is, only the shower head is offered, there are also shower heads that already include some type of flow regulation, as well as some type of mechanism that allows circular movement to direct the rain beam, however the designs are offered integrated so that their parts cannot be separated, therefore when a shower head is purchased one or both are invariably included aforementioned components, which implies having to acquire a new shower head in case any of the components suffers any damage or wear due to use.

In order to solve the problem of replacement and interchangeability of the modules of a shower head when any of its parts breaks down or deteriorates due to use, this modular assembly for a shower head was thought of, which is intended to be protected by means of this application, which due to the interchangeability of its modules it is possible to provide a shower head contained in the patent application PCT/MX2018/000107, a swivel adapter with restrictor diffuser and a flow regulator module with restrictor diffuser, i that can be connected to each other by means of universal threads, to connect to the standard thread of a water supply pipe and that due to the design of the restrictor diffuser, the turbulence of the water flow in the chamber of each module can be reduced, favoring that the rain beam is more uniform and stable, and also the flow of water to the outlet can be reduced when the sum of the areas of the microducts of said diffuser is less than that of the central duct.

In a first preferred embodiment, this modular assembly for shower head is provided as a complete set where the regulator module is connected by female thread to the male thread of the water supply pipe, the swivel adapter is connected by female thread to the male thread of the regulator module and the shower head by female thread connects to the male thread of the swivel adapter.

In a second preferred embodiment this modular shower head assembly can provide a shower head connected directly to the water supply pipe.

In another preferred embodiment in this modular shower head assembly, the shower head can be connected only to the swivel adapter and this adapter to the water supply tube.

In another preferred embodiment, in this modular assembly for a shower head, the shower head can only be connected to the flow regulator module and this to the water supply tube.

As a further embodiment the three components of the modular shower head assembly can be supplied together or separately.

It should be noted that the restrictor diffuser in the water flow regulator module and in the swivel adapter is machined as an integral part of the body of each module and is made up of 12 angled holes, this restrictor diffuser fulfills the function of reducing the flow of water by homogenizing the turbulence in the chamber that forms between this restrictor diffuser and the immediately connected module and, in turn, of promoting a uniform and soft rain beam, providing pleasant comfort to the user at the time of take a bath.

### BRIEF DESCRIPTION OF THE DRAWINGS

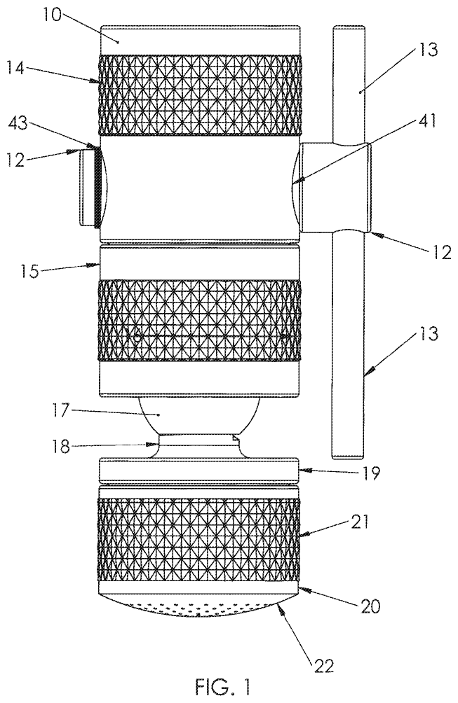

The FIG. 1 is a front view of the modular showerhead assembly.

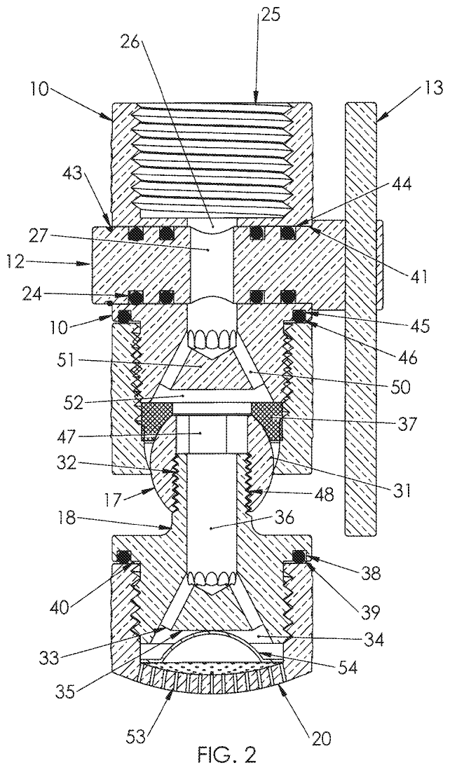

The FIG. 2 is a front sectional view of the modular showerhead assembly.

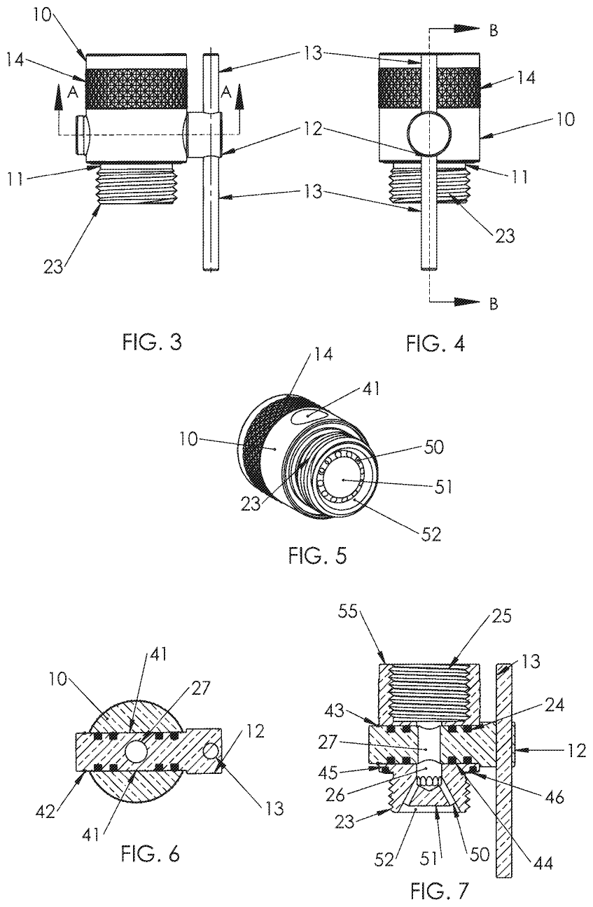

The FIG. 3 is a front view of the water flow regulator module.

The FIG. 4 is a side view of the water flow regulator module.

The FIG. 5 is an isometric view of the body of the water flow regulator module showing the restrictor diffuser.

The FIG. 6 is a sectional view A-A of the water flow regulator module.

The FIG. 7 is a sectional view B-B of the water flow regulator module.

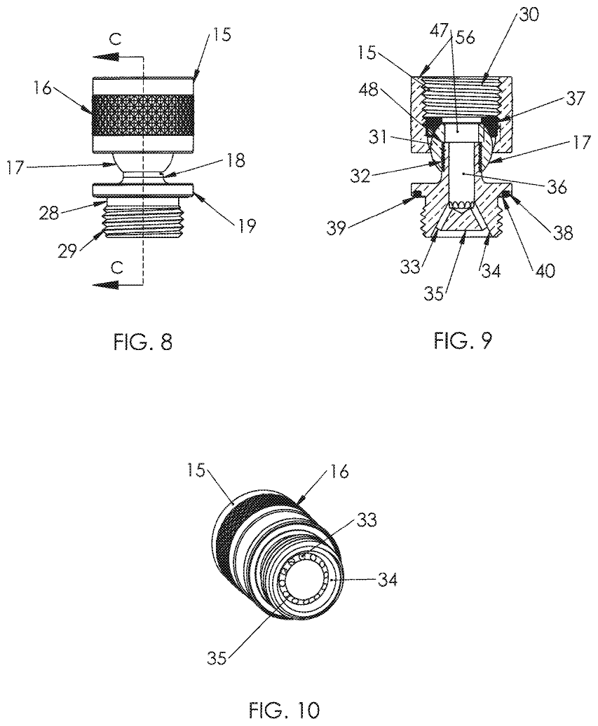

The FIG. 8 is a front view of the swivel adapter.

The FIG. 9 is a sectional view C-C of the swivel adapter.

The FIG. 10 is an isometric view of the swivel adapter, showing the restrictor diffuser.

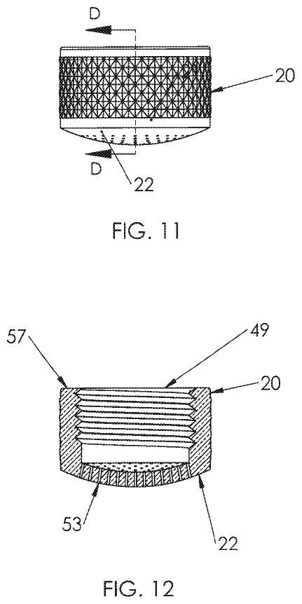

The FIG. 11 is a side view of the shower head. the FIG. 12 is a DD sectional side view of the shower head.

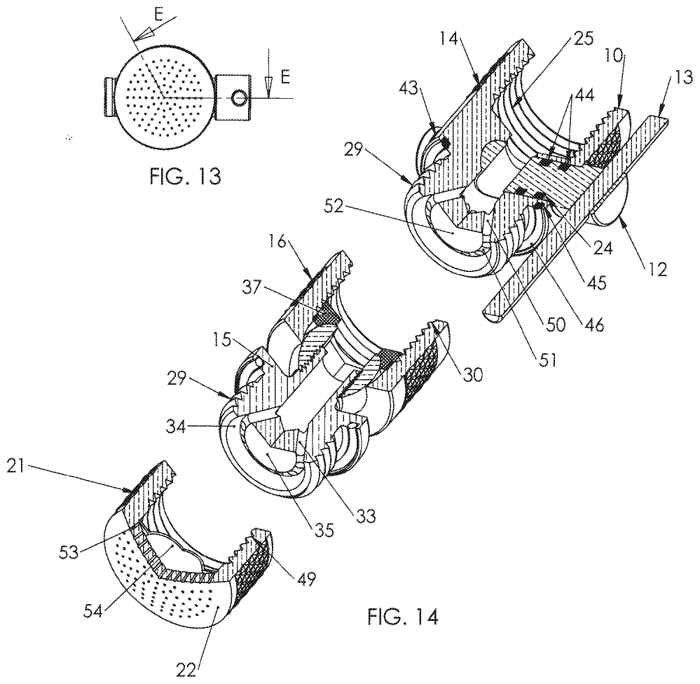

The FIG. 13 is a bottom view of the modular shower head assembly.

The FIG. 14 is an E-E sectional isometric view of the modular showerhead assembly.

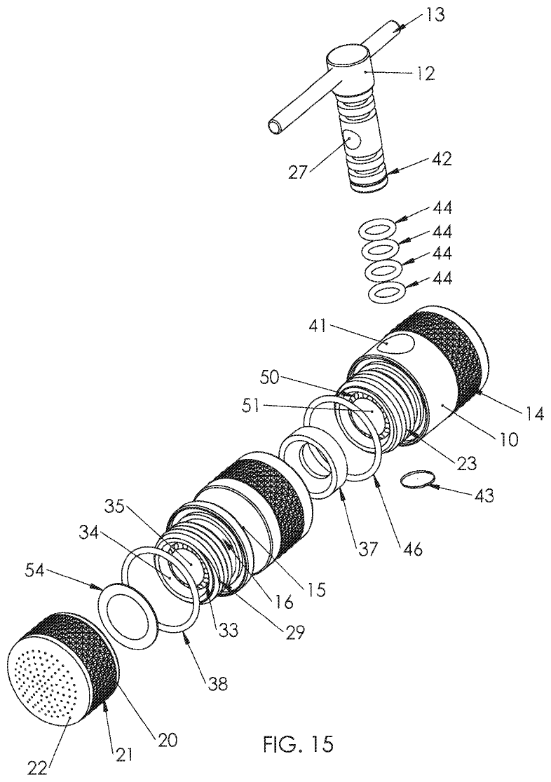

The FIG. 15 is an exploded isometric view of the modular showerhead assembly.

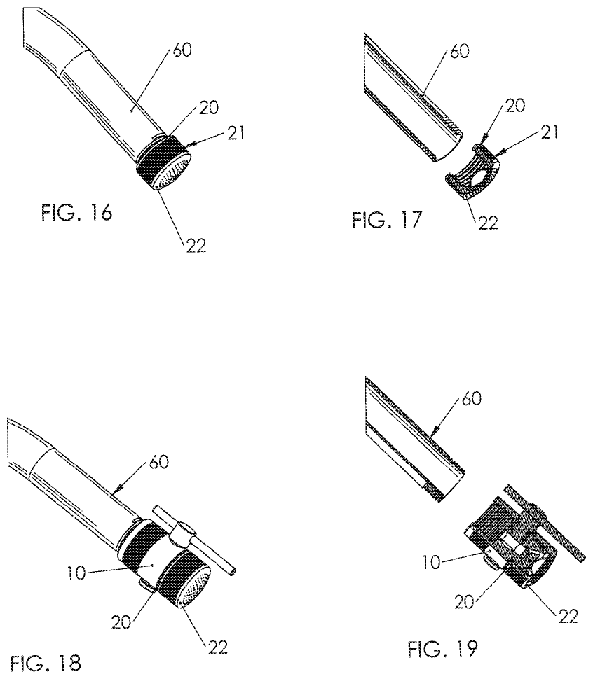

The FIG. 16 is an isometric view showing a first shower head assembly directly connected to the water supply arm.

The FIG. 17 is an exploded isometric view showing a first assembly corresponding to a shower head in concordance with the water supply arm.

The FIG. 18 is an isometric view showing a second assembly corresponding to a shower head and a flow regulator connected to the water supply arm.

The FIG. 19 is an exploded isometric view showing a second assembly corresponding to a shower head and a flow regulator in accordance with the water supply arm.

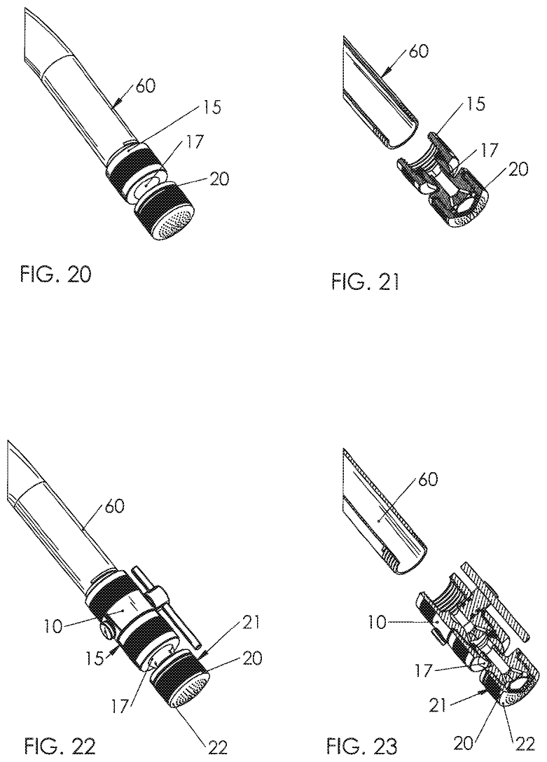

The FIG. 20 is an isometric view showing a third assembly for a shower head and swivel adapter attached to the water supply arm.

The FIG. 21 is an exploded isometric view showing a third assembly for a shower head and swivel adapter in concordance with a water supply arm.

The FIG. 22 is an isometric view showing a complete modular assembly for a shower head, swivel adapter, and flow regulator attached to the water supply arm.

The FIG. 23 is an exploded isometric view showing a fourth assembly corresponding to a shower head and a swivel adapter and a flow regulator in accordance with a water supply arm.

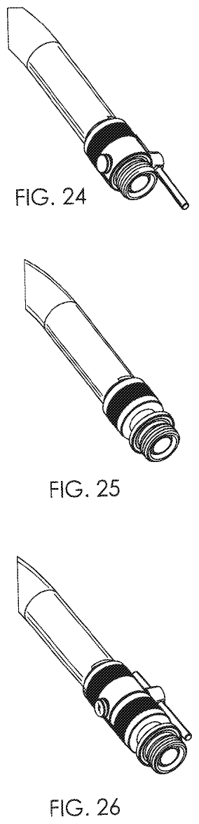

The FIG. 24 is an isometric view showing a flow regulator in conjunction with the water supply arm.

The FIG. 25 is an isometric view showing a ball joint adapter in concordance with the water supply arm.

The FIG. 26 is an isometric showing a flow regulator and swivel adapter in conjunction with the water supply arm.

### DETAILED DESCRIPTION OF THE INVENTION

The present invention refers to a modular assembly for a shower head, preferably made of metallic material under the process of machining, drilling and knurling, and can be made of any other material such as plastic or another, which includes a flow regulator module, a swivel adapter module and a shower head, where said flow regulator module is constituted by a body (10) with knurling (14) to which a hole (26) has not been drilled in correspondence with the thread (25) in which 12 angled holes (50) have been made in the stop (51) that lead into the chamber (52) that is formed between the bell gasket (37) and said stop (51), said body (10) has a through hole (41) that receives the bolt (12) that is secured by a padlock (43) placed in its respective slot (42) said bolt has a perforation (27) that is in direct relation to the hole (26) also incorporates slots (24) on each side of the hole (27) that receive their respective gasket (44) this bolt (12) is topped by a lever (13) that allows turning the bolt to align the hole (27) with the hole (26) of the regulator body (10) and in this way by aligning said holes it is possible to regulate the flow of water, this flow regulator module of water is connected to the supply arm by means of the female thread (25) it also incorporates a projection (11) topped by a male thread (23) said body (10) incorporates a groove (45) that receives the gasket (46) which serves as a seal when this water flow regulator module is assembled and seals when it comes into contact with the surface (56) of the body of the swivel adapter module; the male thread (23) is in correspondence with the female thread (30) of the swivel adapter module, said adapter module is made up of a body (15) with knurling (16) and has an internal cavity (31) that admits a ball joint (17) with a gasket (37) said ball joint (17) has a through hole (47) with a female thread (48) that receives the male thread (32) of the upper projection of the bell (18) that on the face bottom (40) of the base (19) incorporates a slot (38) that receives its respective gasket (39), said bell has a hole (36) that butts up against the wall (35) to which 12 holes have been made. angled holes (33) that lead into the chamber (34) that is formed between said hood and the shower head, said hood incorporates a projection (28) topped by a male thread (29) that receives the female thread (49) of the shower head (20) which incorporates a knurling (21) and micro ducts (53) arranged according to a design that has a flat surface (57) corresponding to cia with the gasket (39) for sealing, in addition to the interior of the shower head a sieve (54) has been incorporated to avoid garbage or impurities that obstruct the micro ducts (53) of the shower head, each module incorporates a surface (55), (56) and (57) which, when in contact with each corresponding module, seal with their respective gaskets (39) and (46).

Through-bolt water flow regulating module sensitively controls the amount of water entering the module by turning the lever and aligning the bolt hole with the hole in the module body and by means of the restrictor diffuser, the turbulence is homogenized and a more uniform flow is delivered to the next module, which is the swivel adapter that offers the possibility of placing the shower head in the desired position and that also incorporates a Restrictor diffuser that works by homogenizing the turbulence of the water that enters said module and that when passing to the shower head, a soft and uniform rain beam is obtained that increases the comfort of the user, also providing the water savings required by Mexican standards.

The modular assembly for the shower head connects directly to the water supply arm, forming a hermetic conduit to the outlet of the water through the shower head, the installation sequence of each module is suggested to be to connect the water flow regulator module to the supply arm, connect the swivel adapter to the water flow regulator module and finally connect the shower head to the swivel adapter, this sequence is modular, since the shower head can be connected directly to the supply arm and dispense with the other two modules, or you can connect to the water supply arm either the water flow regulator module or the swivel adapter and then the shower head, it is pertinent to comment that the modules: regulator water flow valves and swivel adapter are designed to offer a complete concept by projecting a defined image of the design, however|The modules that make up this assembly can be offered commercially together or separately.

Due to the ease of connecting each module by hand and the tightness of the threads of each module when assembling, the use of anti-leak tape is unnecessary.

1. Modular assembly for a shower head, which allows the exchange of the detailed modules, essentially characterized by comprising a water flow regulator module, a swivel adapter and a shower head, where said flow regulator is connected to the water supply arm by means of a female thread, which allows the flow of water through the bolt with a central hole that is in correspondence with the last hole of the regulator body, the bolt is secured by a padlock and sealed by the gaskets placed in the grooves and rotates by a lever to align the central hole with the last hole, which allows or cancels the passage of water to the next module through a hole with a stop where angled holes have been drilled that flow into a chamber in correspondence with the swivel ball adapter, said adapter is connected by a female thread to the male thread of the water flow regulator, likewise incorporates a chamber where a gasket is placed on the ball joint with a central and threaded hole that receives the male thread of the drilled bell that vents to a stop where angled holes have been made that lead into a chamber in correspondence with the head of shower and that incorporates a sieve between the hood and the shower head, said hood incorporates a male thread that receives the female thread of the shower head.

2. Modular assembly for shower head, according to claim 1, characterized in that the water flow regulator module and the swivel joint adapter module incorporate a restrictor diffuser consisting of angled holes that lead into a chamber that is formed by Join each module with the next.

3. Modular assembly for shower head, according to claim 1, characterized in that the modules that make up said assembly are interchangeable, in such a way that the shower head can be connected directly to the water supply arm.

4. Modular assembly for shower head, according to claim 1, characterized in that the modules that make up said assembly are interchangeable, in such a way that the shower head can only be connected to the water flow regulator module and this to the arm of water supply.

5. Modular assembly for shower head, according to claim 1, characterized in that the modules that make up said assembly are interchangeable, in such a way that the shower head can only be connected to the swivel adapter and this to the supply arm of water.

6. Modular assembly for shower head, according to claim 1, characterized in that the modules that make up said assembly can be used in other shower heads.
